(19) United States
(12) Patent Application Publication
(10) Pub. No.: US 2011/0240240 A1
(43) Pub. Date: Oct. 6, 2011

(54) AQUEOUS POLYSILICATE COMPOSITION, ITS PREPARATION AND ITS USE IN PAPERMAKING

(75) Inventors: Sakari Saastamoinen, Hameenlinna (FI); Neil Sidney Harris, South Yorkshire (GB)

(73) Assignee: BASF SE, LUDWIGSHAFEN (DE)

(21) Appl. No.: 13/130,085

(22) PCT Filed: Nov. 12, 2009
(86) PCT No.: PCT/EP09/65069

§ 371 Date: Jun. 23, 2011

(30) Foreign Application Priority Data
Nov. 26, 2008 (GB) 0821527.9

(51) Int. Cl. D21H 17/33; C04B 14/04; C08K 3/34; D21H 17/68

(52) U.S. Cl. 162/164.1; 106/483; 524/450; 162/181.6

(57) ABSTRACT

The invention relates to an aqueous polysilicate composition comprising i) particles of polysilicate seeds, ii) polymerised silicate in intimate association with the polysilicate seeds, iii) cross linkages within the polymerised polysilicate formed from aluminium atoms, aluminium compounds or aluminium ions, iv) cross linkages within the polymerised polysilicate formed from atoms, compounds or ions of a multi-valent metal other than aluminium. Preferably the aqueous polysilicate composition further comprises component v) a water-soluble branched anionic polymer that has been formed from ethylenically unsaturated monomers. The invention also incorporates a method for preparing an aqueous polysilicate composition and also to the use of the aqueous polysilicate composition as a retention/drainage aid in a process of making paper or paperboard.

The present invention relates to an aqueous polysilicate composition and its preparation. Also included in the present invention is a process of making paper and paperboard in which the aqueous polysilicate composition is employed as at least a part of a flocculation system.

It is common practice to use retention and drainage aids in the manufacture of paper and paperboard. For instance cationic polyacrylamides and cationic starch are very effective retention/drainage aids used in papermaking. Subsequently, papermaking systems were developed employing the aforementioned cationic retention aids with inorganic, anionic microparticle materials. Typically such anionic microparticle materials would include swellable clays or aqueous polysilicates such as silica sols or colloidal silica. Generally such processes improved retention and drainage.

U.S. Pat. No. 4,388,150 describes a binder composition comprising colloidal silica and cationic starch for addition to the papermaking stock to improve retention of the stock components or for addition to the white water to reduce pollution problems and to recover stock component values. The colloidal silica may take various forms, including that of polysilicic acid, but the best results are obtained through the use of silica in colloidal form. Polysilicic acid itself is said to be undesirable and without stabilisation deteriorates on storage.

It is known to employ polysilicate microgels as part of the retention or drainage system in the manufacture of paper or paperboard. One method of making polysilicate microgels and their use in paper making processes is described in U.S. Pat. No. 4,954,220. A review of polysilicate microgels is described in the December 1994 Tappi Journal (vol. 77, No 12) at pages 133 to 138. U.S. Pat. No. 5,176,891 discloses a process for the production of polyaluminosilicate microgels involving the initial formation of a polysilicic acid microgel followed by the reaction of this microgel with an aluminate to form the polyaluminosilicate. The use of such polyaluminosilicate microgels in the manufacture of paper is also described.

WO 95/25068 describes an improved method of making polyaluminosilicate microgels over the process of U.S. Pat. No. 5,176,891 in that the micro gels are prepared by a two-step process. Specifically the process involves acidifying an aqueous solution of an alkali metal silicate containing 0.1 to 6% by weight of SiO₂ to a pH of 2 to 10.5 by using an aqueous acidic solution containing an aluminium salt. The second essential step is the dilution of the product of the first step prior to gelation to a SiO₂ content of no more than 2% by weight. In the absence of a dilution step the polyaluminosilicate microgel would gel in a matter of minutes. Even after dilution to as low as 1& these microgels are only stable for a few days and therefore must be used within this time otherwise the product would become a solid gel.

The aforementioned polysilicate microgel products tend to be manufactured on-site since shipping of such products may not allow sufficient time for them to be delivered to the paper mill and consumed before the product has gelled. Furthermore, it may not be economically viable to ship the diluted microgels of solids concentration no more than 2%.

WO 98/56715 seeks to provide a polysilicate microgel that is more storage stable and has a higher concentration. The high concentration polysilicate and aluminated polysilicate microgels involve mixing an aqueous solution of alkali metal silicate with an aqueous phase of silica based material preferably having a pH of 11 or less. The alkali metal silicate used to prepare the polysilicate microgels are said to be any water-soluble silicate salt such as sodium or potassium silicate. The silica based material which is mixed with the alkali metal silicate solution can be selected from a wide variety of siliceous materials and include silica based sols, fumed silica, silica gels, precipitated silicas, acidified solutions of alkali metal silicates, and suspensions of silica containing clays of the smectite type. Although it is stated that the pH of the silica based material is between 1 and 11 it is it is also revealed that most preferably it is between 7 and 11. The pH of the polysilicate microgel is said to be generally below 14 although usually is above 6 and suitably above 9. Microgels are exemplified showing pH values greater than 1%. Example 2 shows the stability of the microgels 1, 3, 5 or 10 days after preparation. However, such microgels will generally still have been manufactured on-site shortly before use.

The polysilicate or polyaluminosilicate microgels tend to be significantly more effective in retention and drainage characteristics of papermaking than the previously conventional colloidal silica or silica sols.

WO 2008/037593 describes an aqueous polysilicate composition comprising a polysilicate microgel based component in association with particles derived from colloidal polysilicate. This composition provides improvements in storage stability by comparison to microgels and yet provides improved retention and drainage characteristics by comparison conventional colloidal silica.

An objective of the present invention is to provide a siliceous product that is an effective retention or drainage aid and yet has significantly longer storage stability than conventional polysilicate microgels. It is also an objective to produce an effective siliceous material for papermaking that has significantly higher silica solids content than many known polysilicate microgels. It would also be desirable to provide such a storage stable, higher solids product that is more effective than conventional colloidal polysilicate. A further objective of the present invention is to develop a product that combines all of the aforementioned advantages and which is more effective than conventional colloidal silica or silica sols that do not contain microgels in the manufacture of paper or board. A still further objective is to provide a silica composition prepared from materials that does not necessarily include microgels.

According to the present invention we provide an aqueous polysilicate composition comprising

i) particles of polysilicate seeds,
ii) polymerised silicate in intimate association with the polysilicate seeds,
iii) cross linkages within the polymerised polysilicate formed from aluminium atoms, aluminium compounds or aluminium ions, and
iv) cross linkages within the polymerised polysilicate formed from atoms, compounds or ions of a multi-valent metal other than aluminium.

In the aqueous polysilicate composition the polymerised silicate may be derived from any suitable silicic acid or salt thereof. Preferably the polymerised silicate is derived from an alkali metal or ammonium silicate. Usually the polymerised silicate would be polymerised in the presence of the polysilicate seed material.

The intimate association between the polymerised silicate and the polysilicate seed material may involve chemical bonding such as covalent or ionic bonds or other forms of chemical bonding such as hydrogen bonds or van der Waals' bonds.

The intimate association between the polymerised silicate component and polysilicate seed material may comprise covalent bonding, for instance as Si—O—Si bond linkages, which may occur by the reaction between condensation reaction of two silanol (silicic acid) end groups.

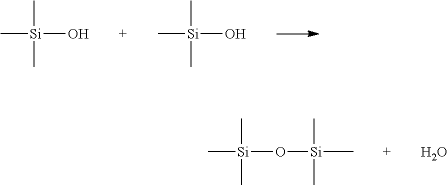

However, the intimate association can be other types of association that result in attraction between the polymerised silicate component and polysilicate seed material. The intimate association may for instance comprise ionic association or alternatively the polysilicate seed material may become physically bound up with the polymerised silicate.

According to a further aspect of the invention we provide a process for preparing an aqueous polysilicate composition comprising the steps,

i) providing an aqueous polysilicate seed material in the form of particles of polysilicate distributed throughout an aqueous medium,
ii) combining the aqueous polysilicate seed material with the following components either simultaneously or sequentially in any order,
a) an aqueous solution of silicic acid or a salt,
b) a compound of aluminium,
c) a compound of a multi-valent metal other than aluminium,
   iii) adjusting the pH of the aqueous silicate to between 2 and below 10.5, thereby causing polymerisation of the aqueous silicate,
   iv) diluting or adjusting the pH of the product of step iii) to at least 10.5 before gelation,
   in which the adjustment of pH in step iii) is commenced when the aqueous polysilicate seed material has been combined with at least (a) the aqueous solution of silicic acid or salt thereof.

We have found that when the aqueous polysilicate composition of the present invention is applied to a papermaking stock as a retention aid significant improvements are observed by comparison to conventional colloidal silica. Typically improvements in retention, drainage and/or formation are observed. The product also improves the runnability of the paper machine as part of the retention aid system. By increasing the dewatering of stock draining on the machine wire we also find a reduction in time required to dry the sheet.

Generally the particles of polysilicate seeds used to form the aqueous polysilicate composition can be any particulate silica based material. Typically the particles of polysilicate seeds are derived from any of the materials selected from a group consisting of silica based particles, silica microgels, colloidal silica, silica sols, silica gels, polysilicates, aluminosilicates, polyaluminosilicates, borosilicates, polyborosilicates and structured silicas. One preferred type of polysilicate seeds includes colloidal silica sols exhibiting an S-value in excess of 55%, especially in the range of 60 to 80%.

As mentioned previously the polymerised silicate component of the polysilicate composition may be derived from any suitable silicic acid or salt thereof. Preferably the polymerised silicate is derived from an alkali metal or ammonium silicate. Sodium silicate is particularly preferred.

The cross linkages within the polymerised polysilicate may be formed from any suitable aluminium atoms, aluminium compounds or aluminium ions. Preferably the source of aluminium will be a water-soluble aluminium compound, more preferably an aluminium halide. A particularly preferred aluminium halide is aluminium chloride.

The further cross linkages within the polymerised polysilicate formed from metal compounds or ions other than aluminium may be formed from any suitable multivalent metal. Preferably the compounds or ions will dissolve in water. Preferably the multivalent metals include multivalent metallic elements from groups IIIa, IVa, V, VIa, VIIa, VIII, Ib, IIb, IIIb, IVb, Vb, VIb, Lanthanides and Actinides. More preferably the multivaltent metals are transition metals. It is particularly preferred that the metal has a valency of at least three. An especially preferred metal is iron. In particular preferred metal compounds include iron III halides, especially iron III chloride.

In a preferred aspect the aqueous polysilicate composition also contains a water-soluble organic polymer. The water-soluble organic polymer may be non-ionic, cationic, amphoteric but preferably is anionic. The water-soluble organic polymer may be natural or seminatural, for example polysaccharides such as starch, anionic starch, cationic starch, amphoteric starch, guar gum, hydroxy ethyl cellulose, carboxymethylcellulose etc.

It is preferred that the polymer is synthetic and more preferably formed from ethylenically unsaturated monomer or monomer blend. Typically such polymers include homopolymers of acrylamide or copolymers of acrylamide with anionic monomers such as acrylic acid, methacrylic acid, maleic acid, crotonic acid, itaconic acid, 2-acrylamido-2-methylpropane sulphonic acid, allyl sulphonic acid and vinyl sulphonic acid and alkali metal or ammonium salts thereof. Alternatively the polymers include copolymers of acrylamide with cationic monomers such as dialkyl amino alkyl -(meth)acrylates or -(meth) acrylamides and their respective quaternary ammonium salts. Such polymers are described in the literature. Preferably the organic polymer is anionic.

The water-soluble organic polymer may be linear or structured, for instance branched. It is particularly preferred that the water-soluble organic polymer is a water-soluble branched anionic polymer that has been formed from ethylenically unsaturated monomers.

The water-soluble branched anionic polymer may be any suitable water-soluble polymer that has at least some degree of branching or structuring, provided that the structuring is not so excessive as to render the polymer insoluble.

The water-soluble branched anionic polymer should be formed from ethylenically unsaturated monomers. Desirably it will be formed from a water soluble monomer or monomer blend comprising at least one anionic or potentially anionic ethylenically unsaturated monomer. The anionic polymer may be post treated in order to render it branched or preferably copolymerised with a monomeric branching agent.

Generally the polymer will be formed from a blend of 5 to 100% by weight anionic water soluble monomer and 0 to 95% by weight non-ionic water soluble monomer. Typically the water soluble monomers have a solubility in water of at least 5 g/100 cc at 25° C. The anionic monomer is preferably selected from the group consisting of acrylic acid, methacrylic acid, maleic acid, crotonic acid, itaconic acid, 2-acrylamido-2-methylpropane sulphonic acid, allyl sulphonic acid and vinyl sulphonic acid and alkali metal or ammonium salts thereof. The non-ionic monomer is preferably selected from the group consisting of acrylamide, methacrylamide, N-vinyl pyrrolidone and hydroxyethyl acrylate.

A particularly preferred monomer blend comprises acrylamide and sodium acrylate.

Post-treatment branching may be brought about by controlled spontaneous conditions such as heating or irradiation of the polymer formed from the aforementioned ethylenically unsaturated monomer or monomer blend. Generally such treatment should provide reproducible and controllable branching.

The branching agent can be any chemical material that causes branching by reaction through the carboxylic or other pendant groups (for instance an epoxide, silane, polyvalent metal or formaldehyde). Preferably the branching agent is a polyethylenically unsaturated monomer which is included in the monomer blend from which the polymer is formed. The amounts of branching agent required will vary according to the specific branching agent.

The amounts of branching agent required will vary according to the specific branching agent. Thus when using polyethylenically unsaturated acrylic branching agents such as methylene bis acrylamide the molar amount is usually below 30 molar ppm and preferably below 20 ppm. Generally it is below 10 ppm and most preferably below 5 ppm. The optimum amount of branching agent is preferably from around 0.5 to 3 or 3.5 molar ppm or even 3.8 ppm but in some instances it may be desired to use 7 or 10 ppm.

Preferably the branching agent is water-soluble. Typically it can be a difunctional material such as methylene bis acrylamide or it can be a trifunctional, tetrafunctional or a higher functional cross-linking agent, for instance tetra allyl ammonium chloride. Generally since allylic monomers tend to have lower reactivity ratios, they polymerise less readily and thus it is standard practice when using polyethylenically unsaturated allylic branching agents, such as tetra allyl ammonium chloride to use higher levels, for instance 5 to 30 or even 35 molar ppm or even 38 ppm and even as much as 70 or 100 ppm.

It may also be desirable to include a chain transfer agent into the monomer mix. Where chain transfer agent is included it may be used in an amount of at least 2 ppm by weight and may also be included in an amount of up to 200 ppm by weight. Typically the amounts of chain transfer agent may be in the range 10 to 50 ppm by weight. The chain transfer agent may be any suitable chemical substance, for instance sodium hypophosphite, 2-mercaptoethanol, malic acid or thioglycolic acid. Preferably, however, the anionic branched polymer is prepared in the absence of added chain transfer agent.

The anionic branched polymer is desirably prepared in the form of a water-in-oil emulsion or dispersion. Typically the polymers are made by reverse phase emulsion polymerisation in order to form a reverse phase emulsion. This product usually has a particle size at least 95% by weight below 10 μm and preferably at least 90% by weight below 2 μm, for instance substantially above 100 nm and especially substantially in the range 500 nm to 1 μm. The polymers may be prepared by conventional reverse phase emulsion or microemulsion polymerisation techniques.

Preferably the water-soluble branched anionic polymer has

(a) intrinsic viscosity above 1.5 dl/g and/or saline Brookfield viscosity (UL viscosity) of above about 2.0 mPa·s and
(b) rheological oscillation value of tan delta at 0.005 Hz of above 0.7

The tan delta at 0.005 Hz value is obtained using a Controlled Stress Rheometer in Oscillation mode on a 1.5% by weight aqueous solution of polymer in deionised water after tumbling for two hours. In the course of this work a Carrimed CSR 100 is used fitted with a 6 cm acrylic cone, with a 1°58′ cone angle and a 58 μm truncation value (Item ref 5664). A sample volume of approximately 2-3 cc is used. Temperature is controlled at 20.0° C.±0.1° C. using the Peltier Plate. An angular displacement of 5×10⁻⁴ radians is employed over a frequency sweep from 0.005 Hz to 1 Hz in 12 stages on a logarithmic basis. G′ and G″ measurements are recorded and used to calculate tan delta (G″/G′) values. The value of tan delta is the ratio of the loss (viscous) modulus G″ to storage (elastic) modulus G′ within the system.

At low frequencies (0.005 Hz) it is believed that the rate of deformation of the sample is sufficiently slow to enable linear or branched entangled chains to disentangle. Network or cross-linked systems have permanent entanglement of the chains and show low values of tan delta across a wide range of frequencies. Therefore low frequency (e.g. 0.005 Hz) measurements can be used to characterise the polymer properties in the aqueous environment.

The anionic branched polymers should have a tan delta value at 0.005 Hz of above 0.7. Preferred anionic branched polymers have a tan delta value of 0.8 at 0.005 Hz. The tan delta value can be at least 1.0 and in some cases can be as high as 1.8 or 2.0 or higher. Preferably the intrinsic viscosity is at least 2 dl/g, for instance at least 4 dl/g, in particular at least 5 or 6 dl/g. It may be desirable to provide polymers of substantially higher molecular weight, which exhibit intrinsic viscosities as high as 16 or 18 dl/g. However, most preferred polymers have intrinsic viscosities in the range 7 to 12 dl/g, especially 8 to 10 dl/g.

Intrinsic viscosity of polymers may be determined by preparing an aqueous solution of the polymer (0.5-1% w/w) based on the active content of the polymer. 2 g of this 0.5-1% polymer solution is diluted to 100 ml in a volumetric flask with 50 ml of 2M sodium chloride solution that is buffered to pH 7.0 (using 1.56 g sodium dihydrogen phosphate and 32.26 g disodium hydrogen phosphate per litre of deionised water) and the whole is diluted to the 100 ml mark with deionised water. The intrinsic viscosity of the polymers is measured using a Number 1 suspended level viscometer at 25° C. in 1M buffered salt solution. Intrinsic viscosity values stated are determined according to this method unless otherwise stated.

The saline Brookfield viscosity (UL viscosity) of the polymer is measured by preparing a 0.1% by weight aqueous solution of active polymer in 1M NaCl aqueous solution at 25° C. using a Brookfield viscometer fitted with a UL adaptor at 6 rpm. Thus, powdered polymer or a reverse phase polymer would be first dissolved in deionised water to form a concentrated solution and this concentrated solution is diluted with the 1M NaCl aqueous. The saline solution viscosity is usually above 2.0 mPa·s and is often at least 2.2 and preferably at least 2.5 mPa·s. In many cases it is not more than 5 mPa·s and values of 3 to 4 are usually preferred. These are all measured at 60 rpm.

In the process of producing the aqueous polysilicate composition according to the present invention each of the components a) an aqueous solution of silicic acid or a salt, b) a compound of aluminium, c) a compound of a multi-valent metal other than aluminium, and where included d) a water-soluble branched anionic polymer that has been formed from ethylenically unsaturated monomers may all be combined with the aqueous polysilicate seed material prior to the adjustment of pH in step iii). However, the adjustment of pH in step iii) may commence prior to the commencement of addition of any, some or all of these components.

The adjustment of pH in step iii) may be commenced after the aqueous polysilicate seed material has been combined with at least (a) the aqueous solution of silicic acid or a salt,

and simultaneously with or after either or both of (b) the compound of aluminium, (c) the compound of multi-valent metal other than aluminium. In this form the water-soluble branched anionic polymer may be added during or after pH adjustment.

Preferably the aqueous polysilicate seed material is first combined with (a) the aqueous solution of silicic acid or a salt. It is preferred that subsequently b) a compound of aluminium, and c) a compound of a multi-valent metal other than aluminium are combined with the aqueous polysilicate seed material substantially simultaneously sequentially. This can be achieved substantially concurrently with the adjustment of pH in step iii). More preferably the (d) the water-soluble branched anionic polymer that has been formed from ethylenically unsaturated monomers is combined with the aqueous polysilicate seed material during or usually subsequent to the adjustment of pH in step iii).

In a preferred aspect of the process of preparing the aqueous polysilicate composition the aqueous polysilicate seed material may be provided with solids content of between 5 and 20% by weight of total composition, for instance between 7 and 15% by weight. Suitably this may be diluted to a concentration between 5 and 10% by weight.

The amount of aqueous silicate combined with the aqueous polysilicate seed material may be between 1 and 20% by weight of the aqueous polysilicate seed material. Preferably this may be between 2 and 15% and more preferably between 3 and 10%, especially between 3 and 7%.

The amount of aluminium compound may be between 5 and 10,000 ppm based on the weight of aqueous polysilicate seed material. Preferably this will be between 10 and 5000 ppm and more preferably between 50 and 1000 ppm.

The amount of multivalent metal compound other than aluminium may be between 5 and 10,000 ppm based on the weight of aqueous polysilicate seed material. Preferably this will be between 10 and 5000 ppm and more preferably between 50 and 1000 ppm.

The amount of water-soluble branched anionic polymer may be as much as 30% based on the weight of aqueous polysilicate seed material and will usually be at least 1%. Preferably, this will be in the range of from 5 and 20%, more preferably between 5 and 15%.

The pH adjustment step should be sufficient to allow polymerisation of the aqueous silicate. This will generally be at a pH of below 10.5 and at least 2. Preferably the pH will be adjusted to at least 4 and up to 10, particularly in the range of 6.5 and 10 often between 7 and 10. It is more preferred still if the pH is between eight and 10 and especially between 8.2 or 8.3 and 10, for instance between 8.2 and 9 especially between 8.4 or 8.5 and 9 or 9.5. Following the adjustment of pH the reaction mixture is desirably aged for a period of between 1 and 10 minutes depending upon the particular pH adjustment. Preferably this ageing is between 2 and 5 minutes, especially where the pH adjustment is to between 7 and 9.

The period adjustment may be achieved by addition of a requisite amount of mineral acid such as sulphuric acid or hydrochloric acid to achieve the desired pH. Alternatively an organic acid may be added such as a carboxylic acid, for instance acetic acid. It may be desirable to adjust the pH using a ion exchange resin or by adding a potentially acidic material such as bubbling carbon dioxide through the reaction mixture. In some cases it may be desirable to add each of the aluminium compound and multivalent metal compound other than aluminium dissolved in the acid used to adjust the pH. Each compound may be added separately dissolved in separate portions of the acid.

Following a suitable ageing period the reaction mixture may be either diluted or the pH adjusted to halt the polymerisation. Preferably the final pH should be adjusted to a pH of at least 10.5, for example with a solution of alkali such as sodium hydroxide solution.

The aqueous polysilicate composition of the present invention is particularly effective when used as a retention/drainage aid in the manufacture of paper or paperboard.

A further aspect of the present invention relates to a process of making paper or paperboard comprising forming a cellulosic suspension, flocculating the cellulosic suspension, draining water from the suspension to form a wet sheet and then drying the sheet, in which the cellulosic suspension is flocculated by the addition of a retention system in which the retention system comprises an aqueous polysilicate composition,

wherein the aqueous polysilicate composition comprises,
i) particles of polysilicate seeds,
ii) polymerised silicate in intimate association with the polysilicate seeds,
iii) cross linkages within the polymerised polysilicate formed from aluminium atoms, aluminium compounds or aluminium ions, and
iv) cross linkages within the polymerised polysilicate formed from atoms, compounds or ions of a multi-valent metal other than aluminium.

In the process of making paper the aqueous polysilicate composition of the present invention may be added to the papermaking stock in any conventional manner.

In the process of making paper or paperboard the polysilicate composition is employed in an amount of at least 25 g per tonne based on dry weight of papermaking stock. This is based on active silica content of the polysilicate composition on the dry weight of papermaking stock. The amount may be as much as 5000 g per tonne or higher but will generally be within the range of 50 to 2000 g per tonne, preferably between 75 and 1000 g per tonne and more preferably between 100 and 7050 g per tonne.

Preferably the retention and drainage system will include a polymeric retention/drainage aid and a micro particulate retention/drainage aid. The polymeric retention/drainage aid can be any of the group consisting of substantially water-soluble anionic, non-ionic, cationic and amphoteric polymers.

The polymeric retention/drainage aids may be natural polymers such as starch or guar gums, which can be modified or unmodified. Preferred natural polymeric retention/drainage aids include cationic starch.

Preferably the polymers are synthetic polymers, for instance polymers prepared by polymerising water-soluble ethylenically unsaturated monomers such as acrylamides, acrylic acid, alkali metal or ammonium acrylates or salified or quaternised dialkyl amino alkyl-(meth)acrylates or -(meth) acrylamides or diallyl dialkyl ammonium halides. More preferably the retention/drainage aids are cationic or amphoteric polymers prepared by the polymerisation of a monomer or monomer blend comprising at least one cationic monomer. Thus cationic polymers may be prepared from one or more cationic monomers selected from the group consisting of salified or quaternised dialkyl amino alkyl-(meth) acrylates or -(meth) acrylamides and diallyl dialkyl ammonium halides optionally with non-ionic monomers such as acrylamide or methacrylamide. Amphoteric polymers may be prepared from the same monomers used to make cationic polymers in addition to anionic monomers such as acrylic acid, alkali metal or ammonium acrylates. Preferably the amphoteric polymers are predominantly cationic.

Usually the polymers will have a high molecular weight, for instance at least 500,000. Preferably the polymers will have molecular weights ranging from at least one million up to 20 or 30 million or higher. Typically the polymers will have molecular weights between 5 and 15 million.

In general the synthetic polymeric retention/drainage aids will exhibit an intrinsic viscosity of at least 3 dl/g and preferably at least 4 dl/g. The polymers may have an intrinsic viscosity as high as 25 dl/g or higher. Preferably the polymers will exhibit intrinsic viscosities at least 6 or 7 dl/g and usually at least 9 or 10 dl/g and up to 16 or 17 dl/g and in some cases up to 19 or 20 dl/g. Intrinsic viscosity is measured by the method described above in relation to the water-soluble branched anionic polymer.

In the process of making paper or paperboard the polymeric retention/drainage aids desirably may be added to a papermaking stock in an amount between 50 and 2000 g per tonne or higher and generally between 100 and 1000 g per tonne, especially between 150 and 800 g per tonne. This is based on active polymer content on the dry weight of papermaking stock.

Suitably the aqueous polysilicate composition may be added to the papermaking stock after the addition of polymeric retention/drainage aid, especially where this is a cationic or predominantly cationic amphoteric polymer. However, in some cases it may be desirable to employ the reverse order of addition. Preferably, the cationic or predominantly cationic amphoteric polymer should be added before a high shear stage such as conventional mixing, pumping or screening stages, for instance a fan pump or a centriscreen. In this case the aqueous polysilicate composition of the present invention may be added after that shear stage. Thus cationic or predominantly cationic amphoteric polymer may be added before a fan pump and the aqueous polysilicate composition of the present invention may be added between the fan pump and centriscreen or alternatively after the centriscreen but before drainage. In another method of addition a cationic or predominantly cationic amphoteric polymer may be added between a fan pump and centriscreen whilst the aqueous polysilicate composition may be added after the centriscreen but before drainage.

The aqueous polysilicate composition of the present invention may also be added to a papermaking process with other chemical additives such as polymeric retention/drainage aids for instance as mentioned herein and added through one or more Trump jets. In this form all of the ingredients may be added simultaneously, for instance after the centriscreen but before drainage.

The following examples illustrate the invention without intending to limit the invention in any way.

### EXAMPLES

In series 1 tests an aqueous colloidal silica (Telioform S20) (200 g), water (202 g) and water glass (Zeopol 33) (11 g) were dosed into a reactor. The resulting solution was mixed using a high shear rotor-stator mixer at 5000 rpm speed. A solution of aluminium chloride (AlCl₃.6H₂O) at a concentration of 200 or 400 WI in 5N hydrochloric acid was added to this solution and then a solution of iron III chloride (FeCl₃) at a concentration of 20 WI in 5N HCl was combined with the solution sufficient to reduce the solution to a reaction pH (R pH) to 7.5, 8.0 or 8.5 respectively. In each case the reaction time was 3 minutes. The reaction mixture was cooled by placing ice around the reaction vessel in order to keep the reaction temperature at room temperature. The final pH was then adjusted to 10.5 with 20% caustic soda. Details of the products prepared are shown in Table 1.

TABLE 1

| | | | | AlC1₃•6H₂O, | FeCl₃, | | |
|---|---|---|---|---|---|---|---|
| Batch | S20, g | water, g | Z 33, g | g/l HCl | g/l HCl | M305, g | R pH |
| 8001 | 200 | 202 | 11.0 | 200 | 20 | 0 | 7.5 |
| 8002 | 200 | 202 | 11.0 | 200 | 20 | 4 | 8.0 |
| 8003 | 200 | 202 | 11.0 | 400 | 20 | 4 | 7.5 |
| 8004 | 200 | 202 | 11.0 | 400 | 20 | 0 | 8.0 |
| 8005 | 200 | 202 | 11.0 | 400 | 20 | 10 | 8.0 |
| 8006 | 200 | 202 | 11.0 | 400 | 20 | 10 | 8.5 |

In series 2 tests the preparation is according to series 1 with the exception of changes in the chemical dosages and the reaction pH indicated in Table 2 below.

TABLE 2

| | | | Sili- | AlC1₃•6H₂O, | FeCl₃, | | |
|---|---|---|---|---|---|---|---|
| Batch | S20, g | water, g | cate, g | g/l HCl | g/l HCl | M305, g | R pH |
| 10001 | 200 | 255 | 11.0 | 400 | 20 | 10 | 8.2 |
| 10002 | 200 | 307 | 11.0 | 450 | 20 | 20 | 8.2 |
| 10003 | 200 | 307 | 11.0 | 400 | 20 | 20 | 8.5 |
| 10004 | 200 | 255 | 11.0 | 450 | 20 | 10 | 8.5 |

The application tests were run with DFR equipment. The head box furnish was collected from a free sheet machine before retention aid addition. The Schopper Riegler (SR) number of the furnish was 28. The head box consistency in the DFR was 0.5%. 1000 rpm for 30 seconds was the polymer shearing condition. Cationic polyacrylamide (Percol 182) was dosed at 300 g/t (dry stock) pre screen (based on active polymer content). The polysilicate composition product was dosed at 300 g/t post screen, based on active silica content on dry stock. The chemical dosages are based on the active content.

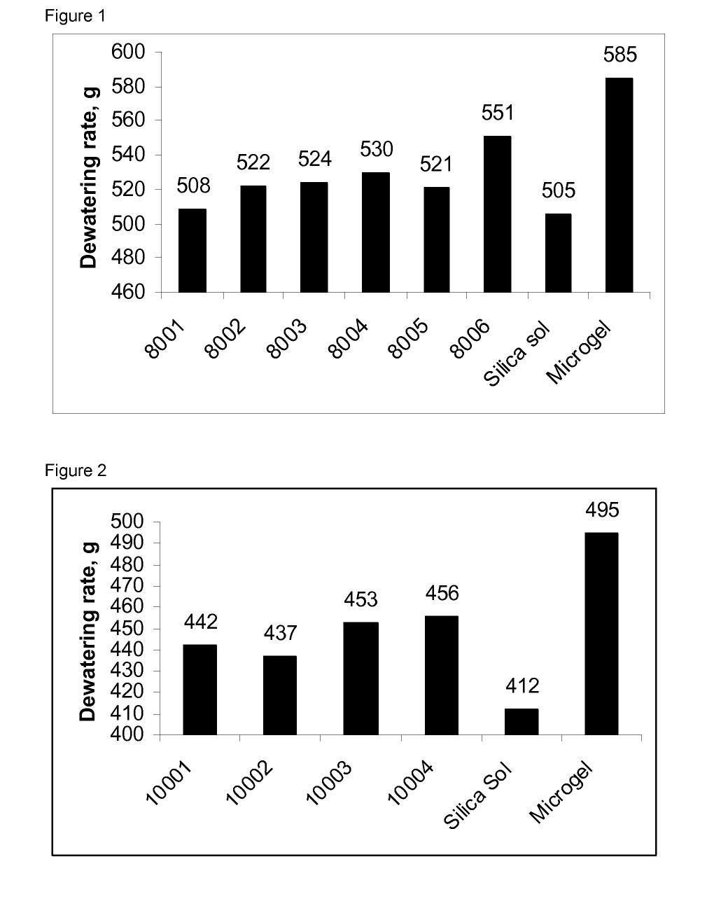

The results are shown in FIGS. 1 to 3.

FIG. 1 shows the dewatering performance of the first series tests.

FIG. 2 shows the dewatering performance of the second series tests.

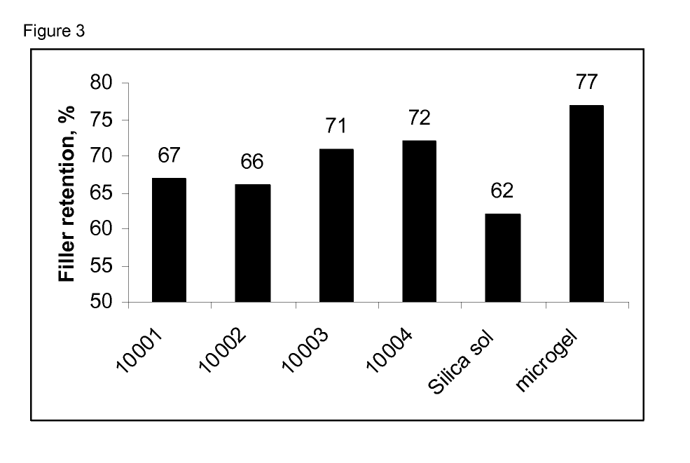

FIG. 3 shows the filler retention of the second series tests.

1. An aqueous polysilicate composition comprising,
i) particles of polysilicate seeds,
ii) polymerised silicate in intimate association with the polysilicate seeds,
iii) cross linkages within the polymerised polysilicate formed from aluminium atoms, aluminium compounds or aluminium ions, and
iv) cross linkages within the polymerised polysilicate formed from atoms, compounds or ions of a multi-valent metal other than aluminium.

2. An aqueous polysilicate composition according to claim 1 which further comprises, component v) a water-soluble branched anionic polymer that has been formed from ethylenically unsaturated monomers.

3. An aqueous polysilicate composition according to claim 1 in which the particles of polysilicate seeds are derived from any of the materials selected from a group consisting of silica based particles, silica microgels, colloidal silica, silica sols, silica gels, polysilicates, aluminosilicates, polyaluminosilicates, borosilicates, and polyborosilicates.

4. An aqueous polysilicate composition according to claim 1 in which the polymerised silicate is derived from an alkali metal or ammonium silicate.

5. An aqueous polysilicate composition according to claim 1 in which cross linkages within the polymerised silicate are formed from an aluminium halide.

6. An aqueous polysilicate composition according to claim 1 in which the cross linkages within the polymerised silicate are formed from an iron III halide.

7. An aqueous polysilicate composition according to claim 1 in which the water-soluble branched anionic polymer is a polymer formed from a monomer or monomer blend comprising an ethylenically unsaturated carboxylic acid or salts thereof.

8. A process for preparing an aqueous polysilicate composition comprising the steps,
i) providing an aqueous polysilicate seed material in the form of particles of polysilicate distributed throughout an aqueous medium,
ii) combining the aqueous polysilicate seed material with the following components either sequentially or simultaneously,
a) an aqueous solution of silicic acid or a salt,
b) a compound of aluminium,
c) a compound of a multi-valent metal other than aluminium,
iii) adjusting the pH of the aqueous silicate to between 2 and below 10.5, thereby causing polymerisation of the aqueous silicate,
iv) diluting or adjusting the pH of the product of step iii) to at least 10.5 before gelation,
in which the adjustment of pH in step iii) is commenced when the aqueous polysilicate seed material has been combined with at least (a) the aqueous solution of silicic acid or salt thereof.

9. A process according to claim 8 in which step ii) further comprises component d) a water-soluble branched anionic polymer that has been formed from ethylenically unsaturated monomers.

10. A process according to claim 8 in which the adjustment of pH in step iii) is commenced after the aqueous polysilicate seed material has been combined with (a) the aqueous solution of silicic acid or a salt,
and simultaneously or after combining the aqueous polysilicate seed material with either or both of (b) the compound of aluminium, (c) the compound of multi-valent metal other than aluminium.

11. A process according to claim 8 in which in step iii) the pH is adjusted to between 8.3 and 10.

12. A process according to claim 8 wherein the particles of polysilicate seeds are derived from any of the materials selected from a group consisting of silica based particles, silica microgels, colloidal silica, silica sols, silica gels, polysilicates, aluminosilicates, polyaluminosilicates, borosilicates, and polyborosilicates.

13. (canceled)

14. A process of making paper or paperboard comprising forming a cellulosic suspension, flocculating the cellulosic suspension, draining water from the suspension to form a wet sheet and then drying the sheet, in which the cellulosic suspension is flocculated by the addition of a retention system in which the retention system comprises an aqueous polysilicate composition,
wherein the aqueous polysilicate composition comprises,
i) particles of polysilicate seeds,
ii) polymerised silicate in intimate association with the polysilicate seeds,
iii) cross linkages within the polymerised polysilicate formed from aluminium atoms, aluminium compounds or aluminium ions, and
iv) cross linkages within the polymerised polysilicate formed from atoms, compounds or ions of a multi-valent metal other than aluminium.

15. A process according to claim 14 in which the particles of polysilicate seeds are derived from any of the materials selected from a group consisting of silica based particles, silica microgels, colloidal silica, silica sols, silica gels, polysilicates, aluminosilicates, polyaluminosilicates, borosilicates, and polyborosilicates.

16. A process according to claim 14 in which the retention system further comprises an amphoteric or cationic polymeric retention aid.
